(19) United States
(12) Patent Application Publication
(10) Pub. No.: US 2024/0425326 A1
(43) Pub. Date: Dec. 26, 2024

(54) DETECTION DEVICE, SENSOR, DETECTION SYSTEM, AND DETECTION METHOD

(71) Applicant: Mitsubishi Electric Corporation, Tokyo (JP)

(72) Inventors: Yusuke FUJIGAYA, Tokyo (JP); Naoki TSURU, Tokyo (JP); Sayaka KOBAYASHI, Tokyo (JP); Kazufumi YOSHIDA, Tokyo (JP); Kyosuke ISHII, Tokyo (JP); Kei SUWA, Tokyo (JP); Takayuki KITAMURA, Tokyo (JP)

(73) Assignee: Mitsubishi Electric Corporation, Tokyo (JP)

(21) Appl. No.: 18/826,255

(22) Filed: Sep. 6, 2024

Related U.S. Application Data
(63) Continuation of application No. PCT/JP2022/012109, filed on Mar. 17, 2022.

(51) Int. Cl. B66B 29/00; G01S 13/28; G01S 13/88; G08B 21/02

(52) U.S. Cl. CPC B66B 29/005; G01S 13/282; G01S 13/887; G08B 21/02

(57) ABSTRACT

A detection device includes processing circuitry configured to acquire sensor information from at least one sensor; the at least one sensor configured to be disposed on at least one of balustrades erected on both right and left sides with respect to a moving direction of steps of at least one passenger conveyor, each of the balustrades including a plurality of side plates; determine whether or not the detection target is a designated target to be warned on a basis of the acquired sensor information; and display a warning image indicating the designated target on a display device in a case where the processing circuitry determines that the detection target is the designated target.

### CROSS-REFERENCE TO RELATED APPLICATION

The present application is a continuation of International Application No. PCT/JP2022/012109, filed Mar. 17, 2022, the entire contents of which is incorporated herein by reference.

### TECHNICAL FIELD

The present disclosure relates to a detection device, a sensor, a detection system, and a detection method.

### BACKGROUND ART

In a place where there are many entering and exiting people, such as a railroad station or various commercial facilities such as a shopping mall, it is required to perform a security check on the entering and exiting people and to detect an object designated in advance (hereinafter referred to as “designated target”) possessed by the entering and exiting people.

Herein, for example, if a person (hereinafter referred to as a “subject”) to be subjected to the security check is allowed to enter an inspection device one by one for inspection, processing efficiency and convenience are poor.

As a technology for improving the processing efficiency and convenience of the security check by performing the security check without the subject entering the inspection device one by one, for example, Patent Literature 1 discloses a technology of irradiating a passing person with an electromagnetic wave, installing a sensor panel that receives a reflected wave above an escalator, and determining whether or not the person possesses a designated target on the basis of a signal of the reflected wave received by the sensor panel.

### CITATION LIST

### Patent Literatures

Patent Literature 1: WO 2021/079501

### SUMMARY OF INVENTION

### Technical Problem

Object detection accuracy by a sensor is improved as a distance between the sensor and an object is shorter. In contrast, a distance between the ceiling and a subject varies depending on a height of the ceiling. Therefore, when a designated target possessed by the subject is to be detected using the conventional technology as disclosed in Patent Literature 1, the detection accuracy of the designated target depends on the height of the ceiling.

In the conventional technology as disclosed in Patent Literature 1, there has been a problem that a designated target possessed by a subject cannot be detected.

The present disclosure is achieved to solve the above-described problem, and an object thereof is to provide a detection device capable of improving detection accuracy of a designated target as compared with the conventional technology in which a designated target possessed by a subject is detected using a sensor provided on the ceiling.

### Solution to Problem

A detection device according to the present disclosure includes processing circuitry configured to acquire sensor information from at least one sensor; the at least one sensor configured to be disposed on at least one of balustrades erected on both right and left sides with respect to a moving direction of steps of at least one passenger conveyor, each of the balustrades including a plurality of side plates; the at least one sensor configured to include: a transmitter to transmit a transmission signal to a space between the right and left balustrades of the at least one passenger conveyor using at least one transmission antenna, the at least one transmission antenna including a plurality of transmission antennas; a receiver to receive a reflection signal obtained by the transmission signal being reflected in the space using at least one reception antenna, the at least one reception antenna including a plurality of reception antennas; and a signal processor to generate the sensor information regarding a detection target on a basis of the received reflection signal received by the receiver, and a plurality of array antenna in which the plurality of transmission antennas and the plurality of reception antennas are arranged, the transmitter transmits the transmission signal using the plurality of transmission antennas arranged linearly, the receiver receives the reflection signal using the plurality of reception antennas linearly arranged in a same direction as a direction of the plurality of transmission antennas, and the plurality of array antennas is linearly arranged in a height direction of a joint of the plurality of side plates on at least one of the right and left balustrades of the at least one passenger conveyor, and determine whether or not the detection target is a designated target to be warned on a basis of the acquired sensor information; and display a warning image indicating the designated target on a display device in a case where the processing circuitry determines that the detection target is the designated target.

### Advantageous Effects of Invention

According to the present disclosure, the detection device according to the present disclosure can improve the detection accuracy of a designated target as compared with the conventional technology in which the designated target possessed by a subject is detected using a sensor provided on the ceiling.

### BRIEF DESCRIPTION OF DRAWINGS

FIG. 1 is a perspective view illustrating a state of an example of an escalator used by a subject in a first embodiment.

FIG. 2 is a perspective view illustrating a state of an example of an entrance of the escalator illustrated in FIG. 1.

FIG. 3 is a view illustrating a state in which a first subject is about to get on the escalator and a second subject gets on the escalator and starts moving.

FIG. 4 is a diagram illustrating a configuration example of a sensor and a detection device according to the first embodiment.

FIG. 5 is a view illustrating a screen example in which a display control unit causes a warning image to be displayed on a display device in the first embodiment.

FIG. 6 is a flowchart for describing an operation of a detection system according to the first embodiment.

FIG. 7 is a flowchart for describing an operation of the detection device according to the first embodiment.

FIGS. 8A and 8B are diagrams illustrating an example of a hardware configuration of the detection device and a sensor according to the first embodiment.

FIG. 9 is a perspective view illustrating a state of an example of the entrance of the escalator in which a sensor is disposed at a joint of inner side plates in the first embodiment.

FIG. 10 is a perspective view illustrating a state of an example of the entrance of the escalator in which the sensor can be disposed on a landing plate installed at the entrance in addition to the place illustrated in FIG. 9 in the first embodiment.

FIG. 11 is a perspective view illustrating a state of an example of the escalator in which a plurality of sensors is arranged on each of right and left balustrades in the first embodiment.

FIG. 12 is a perspective view illustrating a state of an example of the escalator in which a plurality of sensors is arranged on each of the right and left balustrades in the first embodiment.

FIG. 13 is a perspective view illustrating a state of an example of the escalator in which positions in a horizontal direction and positions in a vertical direction with respect to a disposing surface of the balustrade in the escalator are different between a left sensor and a right sensor in the first embodiment.

FIG. 14 is a perspective view illustrating a state of an example of the escalator in which the positions in the horizontal direction and the positions in the vertical direction with respect to the disposing surface of the balustrade in the escalator are different between the left sensor and the right sensor as for the sensor described with reference to FIG. 9 in the first embodiment.

FIGS. 15A and 15B are diagrams for describing a detection range of the left sensor and the right sensor in a case where the left sensor and the right sensor are disposed in such a manner as to face each other and a case where the left sensor and the right sensor are disposed in such a manner that the positions in the horizontal direction and the positions in the vertical direction with respect to the disposing surface of the balustrade in the escalator are different in the first embodiment, top views of a part of the escalator.

FIGS. 16A and 16B are diagrams for describing a detection range of the left sensor and the right sensor in a case where the left sensor and the right sensor are disposed in such a manner as to face each other and a case where the left sensor and the right sensor are disposed in such a manner that the positions in the horizontal direction and the positions in the vertical direction with respect to the disposing surface of the balustrade in the escalator are different in the first embodiment, side views of a part of the escalator.

FIG. 17 is a diagram illustrating a screen example of the display device in a case where the detection device displays a superimposed image on the display device as the warning image in the first embodiment.

### DESCRIPTION OF EMBODIMENTS

A detection device of the present disclosure is used for a security check on a person who uses a passenger conveyor used by a person for moving in a place where many people enter and leave, such as a railroad station or various commercial facilities.

### First Embodiment

Embodiments of the present disclosure are described with reference to the drawings. Herein, an escalator is described as an example of a passenger conveyor, but the present disclosure is also applicable to other passenger conveyors such as a so-called moving walkway.

A detection device detects whether or not a person who uses the escalator possesses an object designated in advance (hereinafter referred to as a “designated target”). In detail, the detection device acquires, from a sensor disposed on a balustrade of the escalator, sensor information regarding a metal object detected by the sensor (hereinafter, referred to as a “detection target”), and determines whether or not the detection target is the designated target on the basis of the acquired sensor information, thereby detecting whether or not the person who uses the escalator possesses the designated target. The balustrade of the escalator is erected on both right and left sides with respect to a moving direction of a step of the escalator.

In a first embodiment, the designated target is assumed to be the metal object that might harm the surroundings. Specifically, the designated target is assumed to be a knife, a kitchen knife, a gun, scissors or the like. When detecting the designated target, the detection device notifies a monitoring person or the like of the detection. When grasping that the detection device detects the designated target, the monitoring person or the like performs a security check on the person who is assumed to possess the designated target. The designated target is determined in advance by the monitoring person or the like depending on a security level in the security check in which the detection device is used.

Note that, the detection target detected by a sensor 1 includes not only the designated target but also various metals assumed not to harm the surroundings, such as a key or a key holder.

In the first embodiment, the sensor is assumed to be, for example, an FMCW millimeter wave radar device. A radio wave in a millimeter wave band passes through clothes of a person and is reflected by a metal object. The detection device can detect, for example, the designated target hidden under the clothes of the person by detecting the designated target using the radio wave in the millimeter wave band.

The sensor transmits a transmission signal to a space between the right and left balustrades of the escalator, and receives a signal of a reflected wave (hereinafter, referred to as a “reflection signal”) obtained by the transmission signal being reflected in the space. The sensor generates the sensor information regarding the detection target on the basis of the received signal, and outputs the generated sensor information to the detection device. The sensor information includes information regarding a distance and an azimuth from the sensor to the detection target.

In the following description of the first embodiment, a person to whom the detection device detects as a target of the detection of whether or not to possess the designated target is referred to as a “subject”.

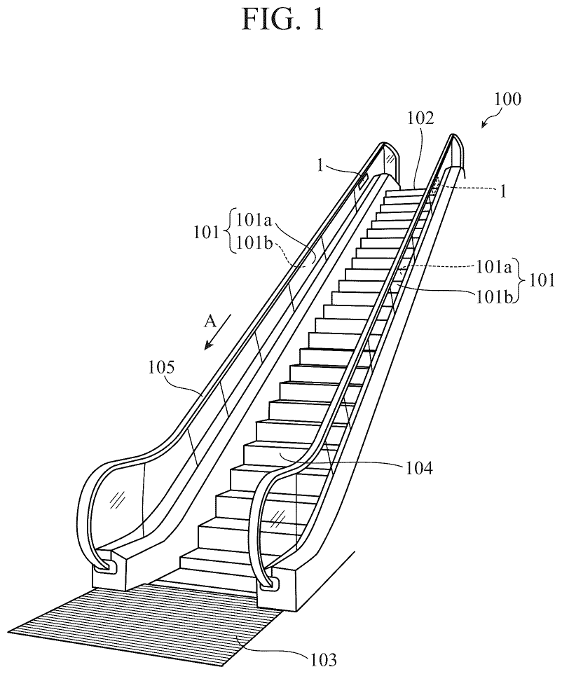

FIG. 1 is a perspective view illustrating a state of an example of an escalator 100 used by the subject in the first embodiment.

The escalator 100 is used by the subject to move between an upper floor and a lower floor.

The escalator 100 is provided with the sensor 1.

The escalator 100 includes a large number of steps 104 that circulate to move as continuous steps, balustrades 101 erected as side walls on both right and left sides with respect to the moving direction of the step 104, and an endless moving handrail 105 that circulates to move in synchronization with the movement of the step 104 while being guided on the balustrade 101. The balustrade 101 includes a plurality of side plates. In the first embodiment, the side plate includes an inner side plate 101a and an outer side plate 101b, and the inner side plate 101a and the outer side plate 101b form a duplex configuration. A plurality of inner side plates 101a is joined and erected in the moving direction of the step 104 on a side on which the subject passes. A plurality of outer side plates 101b is joined and erected in the moving direction of the step 104 on a side opposite to the side on which the subject passes. The inner side plate 101a and the outer side plate 101b are, for example, glass panels.

The escalator 100, specifically the step 104 and the moving handrail 105 illustrated in FIG. 1 are assumed to move in a direction of arrow A from the upper floor toward the lower floor. That is, a platform on the upper floor side serves as an entrance of the escalator 100, and a platform on the lower floor side serves as an exit of the escalator.

Landing plates 102 and 103, each including a rectangular flat plate made of metal such as stainless steel, for example, are installed on the floor portions of the entrance and the exit of the escalator 100, respectively.

In the following first embodiment, the balustrade 101 erected on the left side wall of the step 104 with respect to the moving direction of the step 104 of the escalator 100 is also referred to as a “left balustrade”, and the inner side plate 101a and the outer side plate 101b forming the left balustrade are also referred to as a “left inner side plate” and a “left outer side plate”, respectively. The balustrade 101 erected on the right side wall of the step 104 with respect to the moving direction of the step 104 of the escalator 100 is also referred to as a “right balustrade”, and the inner side plate 101a and the outer side plate 101b forming the right balustrade are also referred to as a “right inner side plate” and a “right outer side plate”, respectively. In the example in FIG. 1, the balustrade 101 illustrated on the right side in the drawing is the left balustrade, and the balustrade 101 illustrated on the left side in the drawing is the right balustrade. Note that, in a case where the left balustrade and the right balustrade are included, they are also collectively referred to as the balustrades 101, in a case where the left inner side plate and the right inner side plate are included, they are also collectively referred to as the inner side plates 101a, and in a case where the left outer side plate and the right outer side plate are included, they are also collectively referred to as the outer side plates 101b.

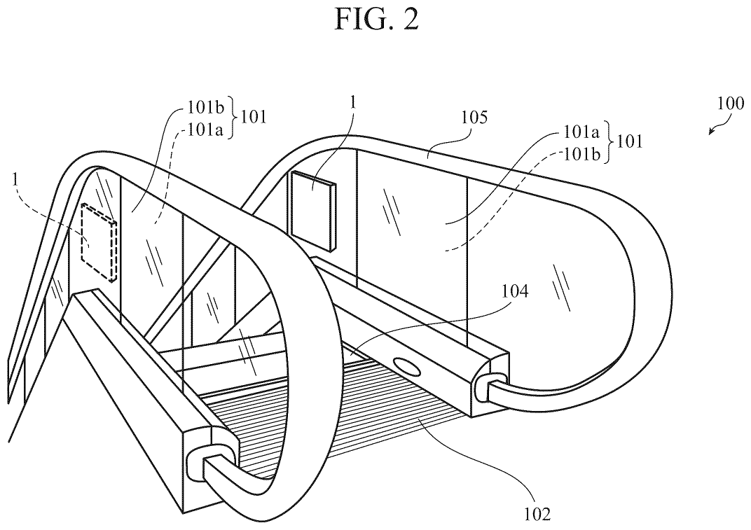

FIG. 2 is a perspective view illustrating a state of an example of the entrance of the escalator 100 illustrated in FIG. 1.

As illustrated in FIG. 2, the sensor 1 is disposed on a surface of the inner side plate 101a of each of the balustrades 101 erected on both right and left sides of the step 104 in a first half range after the step 104 starts moving within a range in which the step 104 can move. In other words, the sensor 1 is disposed on the surface of the inner side plate 101a up to a position to which the subject who uses the escalator 100 moves by a predetermined distance by the escalator 100 after getting on the step 104 from the entrance of the escalator 100. That is, the sensor 1 is disposed on the surface of each of the inner side plates 101a erected on both sides of the step 104 in a case where the step 104 is present between a position of the step 104 immediately after being pulled out, the closest to the entrance, and the position to which the step 104 moves by a predetermined distance.

In the first embodiment, one sensor 1 is disposed on each of the left balustrade and the right balustrade at positions facing each other. In the first embodiment, when the sensor 1 on the left balustrade “faces” the sensor 1 on the right balustrade, this means that the positions in a horizontal direction and the positions in a vertical direction of them with respect to a disposing surface of the balustrade 101 in the escalator 100 are the same. Note that, in the first embodiment, “same” is not limited to “exactly the same”, and includes “substantially the same”.

In the following first embodiment, the sensor 1 disposed on the left balustrade is also referred to as a “left sensor”, and the sensor 1 disposed on the right balustrade is also referred to as a “right sensor”. In an example in FIG. 2, the sensor 1 illustrated on the left side in the drawing is the left sensor, and the sensor 1 illustrated on the right side in the drawing is a right sensor. Note that, in a case where the left sensor and the right sensor are included, they are collectively referred to as the sensors 1.

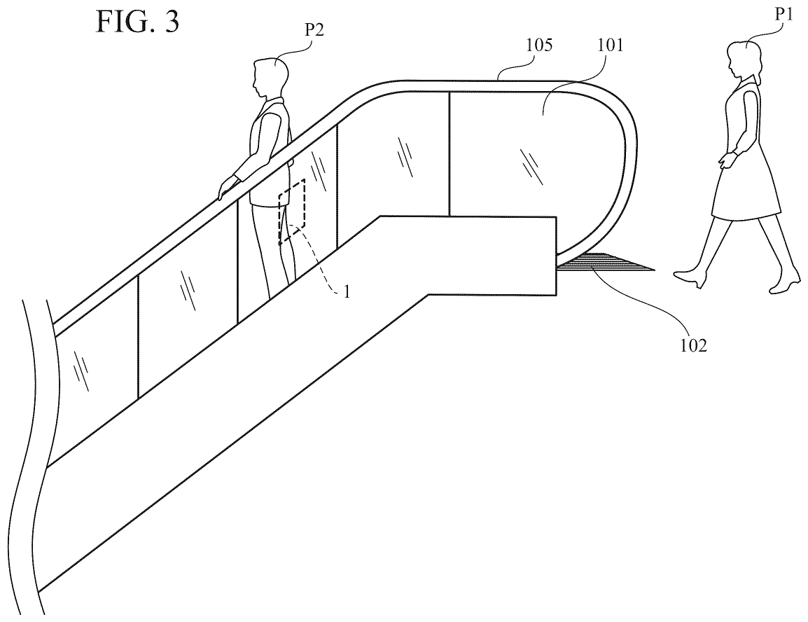

FIG. 3 is a view illustrating a state in which a subject (a first subject indicated by P1 in FIG. 3) is about to get on the escalator 100, and a subject (a second subject indicated by P2 in FIG. 3) gets on the escalator 100 and starts moving. Note that, in FIG. 3, the inner side plate 101a and the outer side plate 101b are not illustrated.

The sensor 1 transmits a transmission signal to a space between the right and left balustrades 101 of the escalator 100 through which the second subject passes. Then, the sensor 1 receives a reflection signal obtained by the transmission signal being reflected in the space. The sensor 1 receives the reflection signal obtained by the transmission signal being reflected by the detection target. The sensor 1 generates sensor information regarding the detection target on the basis of the received reflection signal, and outputs the generated sensor information to the detection device 2. Note that, the sensor 1 assigns, to the sensor information, acquisition date and time of the sensor information and information capable of specifying the sensor 1 that acquires the sensor information, and outputs the same to the detection device 2. The information capable of specifying the sensor 1 is, for example, a unique ID assigned to the sensor 1 in advance, or information indicating a disposing position of the sensor 1 on the escalator 100. The configuration of the sensor 1 is described later in detail.

Note that, the first subject does not yet get on the escalator 100.

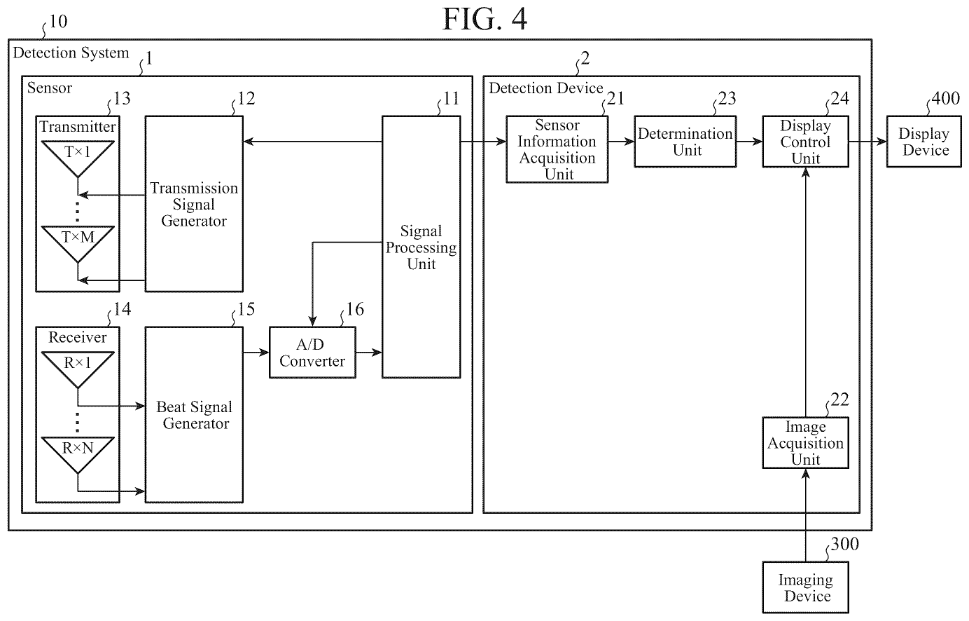

FIG. 4 is a diagram illustrating a configuration example of the sensor 1 and the detection device 2 according to the first embodiment.

In the first embodiment, the detection device 2 is assumed to be mounted on, for example, a server (not illustrated).

The sensor 1 and the detection device 2 form a detection system 10.

The sensor 1 includes a signal processing unit 11, a transmission signal generator 12, a transmitter 13, a receiver 14, a beat signal generator 15, and an A/D converter 16. The transmitter 13 includes M transmission antennas Tx1 to TxM, and the receiver 14 includes N reception antennas Rx1 to RxN.

The signal processing unit 11 controls the transmission signal generator 12 to transmit the transmission signal, and generates the sensor information by performing signal processing on the reception signal of the reflection signal obtained by the transmission signal being reflected. The transmission signal generator 12 is controlled by the signal processing unit 11 to generate the transmission signal, and outputs the transmission signal to the transmitter 13. The transmitter 13 transmits the transmission signal output from the transmission signal generator 12 to the space using the M transmission antennas Tx1 to TxM. The transmission signal generator 12 and the transmitter 13 serve as a transmission unit that transmits the transmission signal to the space.

The receiver 14 receives the reflection signal obtained by the transmission signal being reflected in the space, the reflection signal that returns to the sensor 1 using the N reception antennas Rx1 to RxN. The beat signal generator 15 generates a beat signal, which is an intermediate frequency signal (IF signal), by using the reception signal received by the receiver 14 and the transmission signal transmitted by the transmitter 13, and outputs a beat signal obtained by filtering the generated beat signal to the A/D converter 16.

The A/D converter 16 is controlled by the signal processing unit 11 to perform analog/digital conversion on the beat signal output from the beat signal generator 15. For example, the A/D converter 16 generates digital data for each of the reception antennas Rx1 to RxN by performing sampling at a sampling frequency and with sampling points set in advance from the beat signal corresponding to each of the reception antennas Rx1 to RxN. The receiver 14, the beat signal generator 15, and the A/D converter 16 serve as a reception unit that receives the reflection signal obtained by the transmission signal being reflected in the space.

The M transmission antennas Tx1 to TxM and the N reception antennas Rx1 to RxN form an array antenna (hereinafter, referred to as a one-dimensional array antenna). In the one-dimensional array antenna, for example, the M transmission antennas Tx1 to TxM are linearly arranged, and the N reception antennas Rx1 to RxN are linearly arranged in the same direction as the direction of the transmission antennas.

The one-dimensional array antenna includes, for example, a substrate (not illustrated), the M transmission antennas Tx1 to TxM, and the N reception antennas Rx1 to RxN. Each of the transmission antennas Tx1 to TxM is supplied with power via the substrate, and each of the reception antennas Rx1 to RxN outputs the reception signal to the receiver 14 via the substrate.

The signal processing unit 11 allows the transmission unit and the reception unit to repeatedly execute a series of pieces of processing of simultaneously transmitting the transmission signals from the M transmission antennas Tx1 to TxM, and receiving the reflection signals obtained by reflecting the transmission signals by the reception antennas Rx1 to RxN to acquire the digital data of the reception signals.

The signal processing unit 11 generates the sensor information of the detection target by using the digital data sequentially acquired for the detection target.

The signal processing unit 11 outputs the generated sensor information to the detection device 2.

The detection device 2 is connected to the sensor 1, an imaging device 300, and a display device 400, and determines whether or not the detection target is the designated target on the basis of the sensor information acquired from the sensor 1. In a case of determining that the detection target is the designated target, the detection device 2 causes an image for warning of detection of the designated target (hereinafter, referred to as a “warning image”) to be displayed on the display device 400. The display device 400 is provided on, for example, a tablet terminal (not illustrated) carried by the monitoring person or the like who performs the security check on the subject. The display device 400 may be provided on, for example, a personal computer (PC) installed in a monitoring room in which the monitoring person or the like is resident.

The detection device 2 causes a captured image acquired from the imaging device 300 to be displayed on the display device 400 together with the warning image.

The imaging device 300 includes, in an imaging range, the space to which the sensor 1 transmits the transmission signal. For example, the imaging device 300 images the subject who gets on the escalator 100 from the front in the vicinity of the entrance of the escalator 100. For example, the imaging device 300 may be installed in such a manner as to be able to image the entire escalator 100 and the subject who uses the escalator 100.

The image caused to be displayed by the detection device 2 on the display device 400 is described later in detail.

A sensor information acquisition unit 21 acquires the sensor information from the sensor 1.

The sensor information acquisition unit 21 outputs the acquired sensor information to a determination unit 23.

An image acquisition unit 22 acquires the captured image from the imaging device 300.

The image acquisition unit 22 outputs the acquired captured image to a display control unit 24.

On the basis of the sensor information acquired by the sensor information acquisition unit 21, the determination unit 23 determines whether or not the detection target is the designated target to be warned.

For example, the determination unit 23 generates a three-dimensional radar image regarding the detection target on the basis of the sensor information, and determines whether or not the detection target is the designated target on the basis of the generated three-dimensional radar image. Note that, as described above, the sensor information includes the information regarding the distance and the azimuth from the sensor 1 to the detection target. The determination unit 23 can specify a position and a shape of the detection target on the basis of the sensor information.

For example, the determination unit 23 determines whether or not the detection target is the designated target by using a trained model in machine learning (hereinafter, referred to as a “machine learning model”).

The machine learning model is already trained to use the three-dimensional radar image as an input, and output information indicating whether or not the detection target illustrated in the three-dimensional radar image is the designated target. The machine learning model is generated in advance and stored in a place to which the determination unit 23 can refer.

For example, the determination unit 23 may determine whether or not the detection target is the designated target to be warned using a known image recognition technology such as template matching or pattern matching.

The determination unit 23 outputs a determination result as to whether or not it is determined that the detection target is the designated target to the display control unit 24. The determination unit 23 includes the three-dimensional radar image and the sensor information in the determination result.

The display control unit 24 causes the warning image based on the determination result output from the determination unit 23 to be displayed on the display device 400. In detail, the display control unit 24 generates information for displaying the warning image (hereinafter referred to as “warning information”), outputs the warning information to the display device 400, and causes the warning image to be displayed on the display device 400.

Specifically, in a case where the determination unit 23 determines that the detection target is the designated target, the display control unit 24 causes the warning image illustrating the designated target to be displayed on the display device 400. For example, the display control unit 24 displays the three-dimensional radar image included in the determination result on the display device 400 as the warning image.

At that time, the display control unit 24 displays the captured image acquired by the image acquisition unit 22 on the display device 400 together with the warning image.

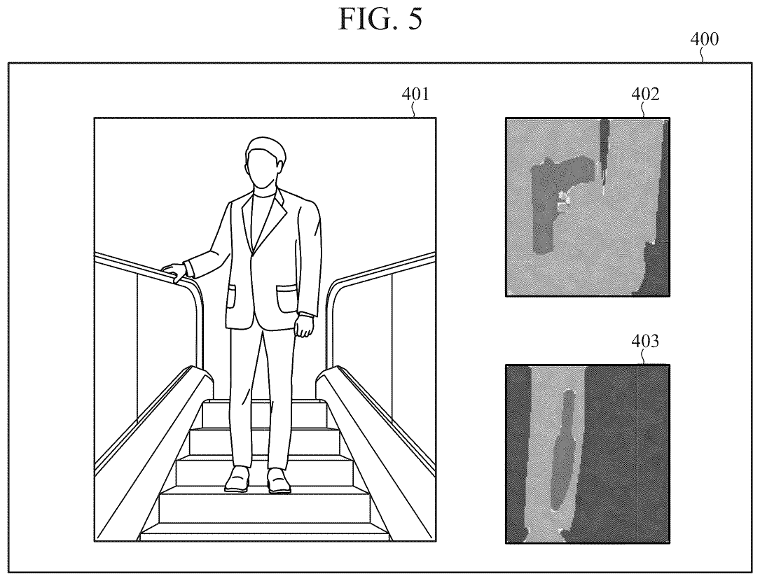

Herein, FIG. 5 is a view illustrating a screen example in which the display control unit 24 causes the warning image to be displayed on the display device 400 in the first embodiment.

FIG. 5 illustrates the screen example in a case where the sensor 1 detects two detection targets, and the determination unit 23 determines that the detection targets are a handgun and a knife, each of which is the designated target.

For example, the display control unit 24 displays the captured image in a first area (an area indicated by 401 in FIG. 5) of a display area of the display device 400, displays the warning image illustrating the handgun in a second area (an area indicated by 402 in FIG. 5), and displays the captured image illustrating the knife in a third area (an area indicated by 403 in FIG. 5).

Note that, the screen example illustrated in FIG. 5 is merely an example. For example, the display control unit 24 can set sizes of the first area, the second area, and the third area to sizes according to the needs. For example, the display control unit 24 can change arrangement of the first area, the second area, and the third area according to the needs.

For example, the display control unit 24 may display the acquisition date and time of the sensor information in association with the warning image, or may display the information capable of specifying the sensor 1 from which the sensor information is acquired in association with the warning image.

For example, the display control unit 24 may display the warning image to blink, or may set an image in which a warning message such as “handgun possessed” or “knife possessed” is assigned to the three-dimensional radar image as the warning image. Note that, the determination unit 23 may include information indicating the type of the designated target in the determination result and output the information to the display control unit 24. For example, when displaying the warning image, the display control unit 24 may output a warning sound from a sound output device (not illustrated). The sound output device is provided on, for example, the tablet terminal carried by the monitoring person or the like or the PC installed in the monitoring room.

For example, when the monitoring person or the like checks the screen displayed on the display device 400 and specifies the subject who possesses the designated target, the monitoring person or the like stops the subject who gets off the escalator 100 and performs the body check.

The display control unit 24 causes the captured image to be displayed on the display device 400, so that it is easy for the monitoring person or the like to specify which subject is the subject who possesses the designated target.

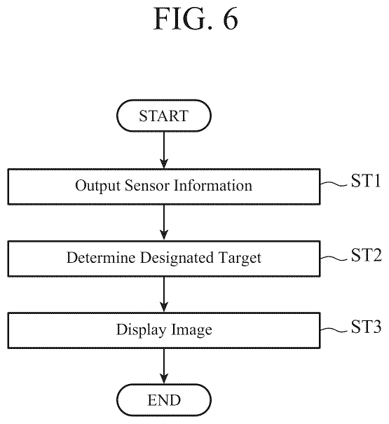

FIG. 6 is a flowchart for describing an operation of the detection system 10 according to the first embodiment.

The sensor 1 transmits the transmission signal to the space as a radio wave, and receives the reflection signal obtained by the transmitted radio wave being reflected by the detection target present in the space, the reflection signal that returns, thereby generating the sensor information regarding the detection target. Specifically, in the sensor 1, the transmission unit transmits the transmission signal to the space between the right and left balustrades 101 of the escalator 100 using the transmission antennas Tx1 to TxM, and the reception unit receives the reflection signal obtained by the transmission signal being reflected in the space using the reception antennas Rx1 to RxN. Then, the signal processing unit 11 generates the sensor information regarding the detection target on the basis of the reflection signal received by the reception unit.

The sensor 1 outputs the sensor information to the detection device 2 (step ST1).

On the basis of the sensor information output from the sensor 1, the detection device 2 determines whether or not the detection target is the designated target to be warned (step ST2).

Then, the detection device 2 causes the warning image based on the determination result to be displayed on the display device 400 (step ST3).

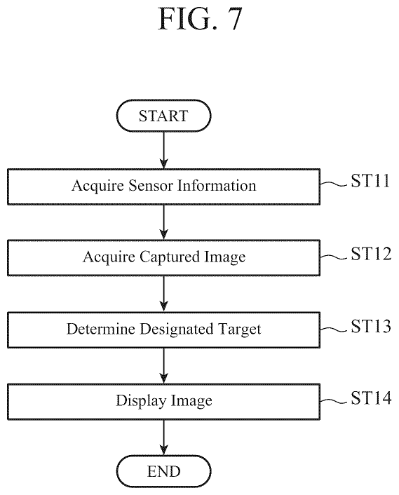

FIG. 7 is a flowchart for describing an operation of the detection device 2 according to the first embodiment.

The sensor information acquisition unit 21 acquires the sensor information from the sensor 1 (step ST11).

The sensor information acquisition unit 21 outputs the acquired sensor information to a determination unit 23.

The image acquisition unit 22 acquires the captured image from the imaging device 300 (step ST12).

The image acquisition unit 22 outputs the acquired captured image to the display control unit 24.

On the basis of the sensor information acquired by the sensor information acquisition unit 21 at step ST11, the determination unit 23 determines whether or not the detection target is the designated target to be warned (step ST13).

The determination unit 23 outputs the determination result as to whether or not it is determined that the detection target is the designated target to the display control unit 24 in association with the sensor information.

The display control unit 24 causes the warning image based on the determination result output from the determination unit 23 at step ST13 to be displayed on the display device 400 (step ST14).

At that time, the display control unit 24 causes the captured image acquired by the image acquisition unit 22 at step ST12 to be displayed on the display device 400 together with the warning image.

Note that, in the flowchart illustrated in FIG. 7, processing is performed in the order of step ST11, step ST12, and step ST13, but this is merely an example. It is sufficient that the processing at step ST12 is performed before the processing at step ST14 is performed.

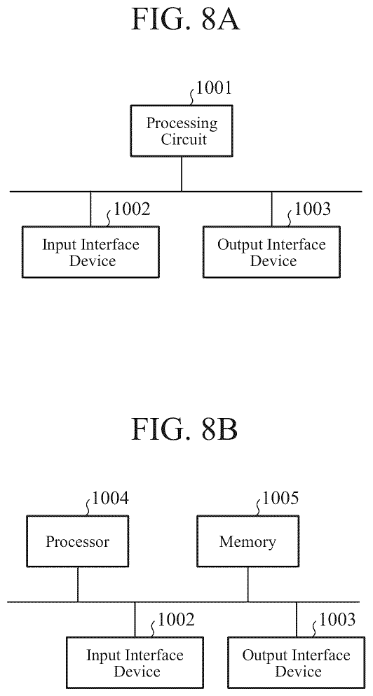

FIGS. 8A and 8B are diagrams illustrating an example of a hardware configuration of the detection device 2 according to the first embodiment.

In the first embodiment, functions of the sensor information acquisition unit 21, the image acquisition unit 22, the determination unit 23, and the display control unit 24 are implemented by a processing circuit 1001. That is, the detection device 2 includes the processing circuit 1001 for performing control of acquiring the sensor information regarding the detection target possessed by the person who uses the escalator detected by the sensor 1, determining whether or not the person who uses the escalator possesses the designated target by determining whether or not the detection target is the designated target on the basis of the acquired sensor information, and causing the warning image illustrating the designated target to be displayed on the display device 400 together with the captured image captured by the imaging device 300.

The processing circuit 1001 may be dedicated hardware as illustrated in FIG. 8A or a processor 1004 that executes a program stored in a memory 1005 as illustrated in FIG. 8B.

In a case where the processing circuit 1001 is the dedicated hardware, the processing circuit 1001 corresponds to, for example, a single circuit, a composite circuit, a programmed processor, a parallel-programmed processor, an application specific integrated circuit (ASIC), a field-programmable gate array (FPGA), or a combination of them.

In a case where the processing circuit is the processor 1004, the functions of the sensor information acquisition unit 21, the image acquisition unit 22, the determination unit 23, and the display control unit 24 are implemented by software, firmware, or a combination of software and firmware. Software or firmware is described as a program and stored in the memory 1005. The processor 1004 executes the functions of the sensor information acquisition unit 21, the image acquisition unit 22, the determination unit 23, and the display control unit 24 by reading and executing the program stored in the memory 1005. That is, the detection device 2 is provided with the memory 1005 for storing the program that eventually executes steps ST11 to ST14 in FIG. 7 described above when being executed by the processor 1004. It can also be said that the program stored in the memory 1005 allows a computer to execute a procedure or a method performed by the sensor information acquisition unit 21, the image acquisition unit 22, the determination unit 23, and the display control unit 24. Herein, the memory 1005 is a non-volatile or volatile semiconductor memory such as a RAM, a read only memory (ROM), a flash memory, an erasable programmable read only memory (EPROM), and an electrically erasable programmable read only memory (EEPROM), a magnetic disk, a flexible disk, an optical disk, a compact disc, a mini disc, a digital versatile disc (DVD) or the like.

Note that, a part of the functions of the sensor information acquisition unit 21, the image acquisition unit 22, the determination unit 23, and the display control unit 24 may be implemented by dedicated hardware and a part of them may be implemented by software or firmware. For example, the processing circuit 1001 as the dedicated hardware may implement the functions of the sensor information acquisition unit 21 and the image acquisition unit 22, and the processor 1004 may implement the functions of the determination unit 23 and the display control unit 24 by reading an executing the program stored in the memory 1005.

The detection device 2 is provided with an input interface device 1002 and an output interface device 1003 that perform wired communication or wireless communication with the device such as the sensor 1, the imaging device 300, or the display device 400.

A hardware configuration example for implementing the function of the sensor 1 is also as illustrated in FIGS. 8A and 8B.

In FIGS. 8A and 8B, the input interface device 1002 and the output interface device 1003 are interfaces that inputs the digital data A/D converted by the A/D converter 16, and relays a control signal from the signal processing unit 11 to output to the transmission unit and the reception unit.

The function of the signal processing unit 11 is implemented by a processing circuit. That is, the signal processing unit 11 includes the processing circuit that executes the processing at step ST1 in FIG. 6. The processing circuit may be dedicated hardware, but may also be a CPU that executes a program stored in a memory.

When the processing circuit is the processing circuit 1001 of the dedicated hardware illustrated in FIG. 8A, the processing circuit 1001 corresponds to, for example, a single circuit, a composite circuit, a programmed processor, a parallel-programmed processor, an application specific integrated circuit (ASIC), a field-programmable gate array (FPGA), or a combination of them.

In a case where the processing circuit is the processor 1004 illustrated in FIG. 8B, a function of the signal processing unit 11 is implemented by software, firmware, or a combination of software and firmware. Note that, the software or firmware is described as a program and stored in the memory 1005.

The processor 1004 implements the function of the signal processing unit 11 by reading and executing the program stored in the memory 1005. For example, the signal processing unit 11 includes the memory 1005 that stores the program by which the processing at step ST1 illustrated in FIG. 6 is eventually executed when being executed by the processor 1004. These programs allow the computer to execute the procedure or the method performed by the signal processing unit 11. The memory 1005 may be a computer-readable storage medium storing a program for allowing the computer to serve as the signal processing unit 11.

A part of the functions of the signal processing unit 11 may be implemented by dedicated hardware, and the remaining part may be implemented by software or firmware. In this manner, the processing circuit can implement the above-described function by the hardware, software, firmware, or combination thereof.

As described above, the detection device 2 acquires the sensor information from the sensor 1. The sensor 1 is disposed on the balustrade 101 erected on each of both right and left sides with respect to the moving direction of the step 104 of the escalator 100, the balustrade 101 including a plurality of side plates, transmits the transmission signal to the space between the right and left balustrades 101 of the escalator 100, receives the reflection signal obtained by the transmission signal being reflected in the space, and generates the sensor information regarding the detection target on the basis of the received reception signal. The detection device 2 determines whether or not the detection target is the designated target on the basis of the sensor information. In a case where the detection device 2 determines that the detection target is the designated target, this causes the warning image illustrating the designated target to be displayed on the display device 400.

The detection device 2 can detect the designated target possessed by the subject by allowing the subject to perform a natural motion without allowing the subject to be aware that the security check is being performed.

At that time, the detection device 2 can accurately detect the designated target.

As described above, in the conventional technology as described above, the detection accuracy of the object possessed by the subject depends on the height of the ceiling, so that there has been a possibility that the designated target possessed by the subject is not detected.

In contrast, in the detection system 10 according to the first embodiment, the sensor 1 is disposed on the balustrade 101 of the escalator 100. In general, a distance between the subject and the balustrade 101 of the escalator 100 is shorter than a distance between the subject and the ceiling. Therefore, in the detection system 10 according to the first embodiment, the detection accuracy of the detection target by the sensor 1 can be improved as compared with the conventional technology. As a result, the detection accuracy of the designated target possessed by the subject by the detection device 2 can be improved as compared with the conventional technology.

Note that, for example, in the conventional technology as described above, it is also conceivable to dispose a sensor panel on each of both sides of a passage through which the subject passes. However, a shape or the like of the passage through which the subject passes vary depending on a building. A position or speed on the passage of the subject who passes varies depending on the subject. Therefore, it is difficult for the monitoring person or the like to find a disposing position of the sensor panel capable of accurately detecting the detection target possessed by the subject. That is, a problem that the detection accuracy of the designated target is not ensured arises. As a result, there still is a possibility that the designated target possessed by the subject is not detected as described above.

In contrast, in the detection system 10 according to the first embodiment, the sensor 1 is disposed on the balustrade 101 of the escalator 100. A criterion for installation of the escalator 100 is clearly defined in advance, and a positional relationship between the subject who gets on and off the escalator 100 and the balustrade 101 of the escalator 100 is easily calculated. Therefore, it is easy for the monitoring person or the like to find the disposing position of the sensor 1 suitable for accurately detecting the detection target possessed by the subject. Therefore, the sensor 1 is disposed at a position where the detection accuracy of the detection target can be ensured. As a result, in the detection system 10, the sensor 1 can ensure the detection accuracy of the detection target. As a result, the detection device 2 can ensure the detection accuracy of the designated target possessed by the subject. That is, the detection device 2 can improve the detection accuracy of the designated target possessed by the subject as compared with a case where the sensor panel is disposed on each of both sides of the passage through which the subject passes.

Note that, even when the passenger conveyor is a so-called moving walkway, a criterion for installation of the moving walkway is clearly defined in advance.

In general, even when a person walks or the like at a certain speed up to the vicinity of the entrance of the escalator 100, the person stops walking or the like on the step 104 in a state of getting on the step 104. In the example illustrated in FIG. 3, the first subject walks at a certain speed because the first subject does not yet get on the escalator 100, but the second subject stops walking and stands still because the second passenger gets on the escalator 100. That is, a moving speed of the second subject is a moving speed of the step 104. In most escalators 100, the moving speed of the step 104 is generally defined to be a speed lower than the speed regarded as a walking speed of a person. In the detection system 10 according to the first embodiment, the sensor 1 is disposed on the balustrade 101 erected on each of both right and left sides of the step 104 of the escalator 100 within the range in which the step 104 can move, so that the sensor 1 detects the detection target possessed by the subject with respect to the subject whose moving speed is lower than a walking speed in a state of not getting on the escalator 100. Therefore, in the detection system 10, the sensor 1 can improve the detection accuracy of the detection target as compared with a case where the sensor panel is disposed on each of both sides of the passage through which the subject passes. The lower the speed of the detection target, the easier the sensor 1 can detect the detection target. As a result, the detection device 2 can improve the detection accuracy of the designated target possessed by the subject as compared with a case where the sensor panel is disposed on each of both sides of the passage through which the subject passes. The moving speed of the step 104 is constant, so that the sensor 1 can stably detect the detection target in the detection system 10. As a result, the detection device 2 can stably detect the designated target possessed by the subject.

Note that, as a method of detecting the detection target in the escalator 100, for example, a method of installing an imaging device on the balustrade 101 in the vicinity of the entrance of the escalator 100 and detecting the detection target on the basis of a captured image captured by the imaging device is also conceivable. However, the imaging device cannot detect the detection target hidden by the subject. The detection system 10 can detect the detection target hidden by the subject by adopting the sensor 1 for detection of the detection target. The detection device 2 can detect the designated target hidden by the subject by determining whether or not the subject possesses the designated target on the basis of the sensor information acquired from the sensor 1.

### <Variation (1)>

In the first embodiment described above, as described with reference to FIGS. 1 and 2, the sensor 1 is disposed on the surface of each of the left and right inner side plates 101a, but this is merely an example.

For example, the sensor 1 may be disposed at a joint of the inner side plates 101a on each of the right and left balustrades 101.

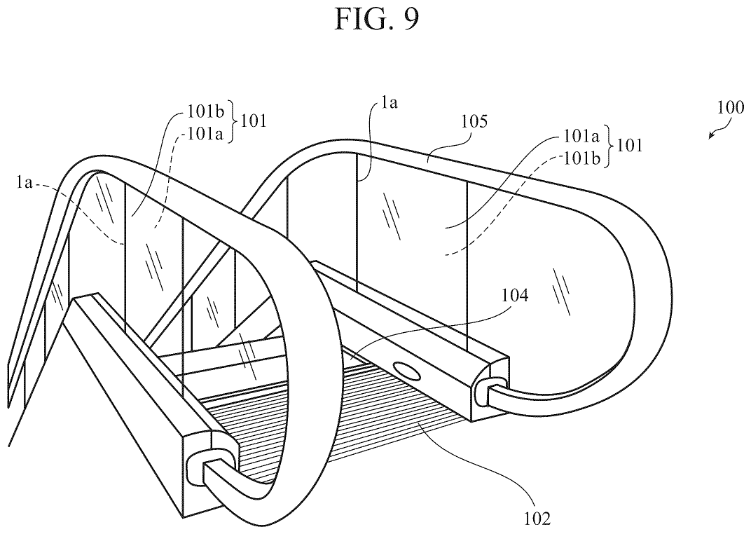

FIG. 9 is a perspective view illustrating a state of an example of the entrance of the escalator 100 in which a sensor 1a is disposed at the joint of the inner side plates 101a in the first embodiment.

In this case, the sensor 1a has, for example, a configuration in which a plurality of substrates is arranged in a height direction of the balustrade 101. In detail, the sensor 1a includes a plurality of one-dimensional array antennas in which a plurality of transmission antennas Tx1 to TxM and a plurality of reception antennas Rx1 to RxN are arranged, and the plurality of one-dimensional array antennas is linearly arranged in the height direction of each of the right and left balustrades 101. Note that, a configuration example of the sensor 1a is similar to the configuration example of the sensor 1 already described except that a plurality of one-dimensional array antennas is included.

The sensor 1a in which a plurality of substrates is arranged in the height direction of the balustrade 101 is disposed at the joint of the inner side plates 101a, so that a detection range of the sensor 1a can be expanded in the height direction of the balustrade 101. As a result, the detection device 2 can detect the designated target possessed by the subject in a range corresponding to almost the whole body of the subject.

The sensor 1a is disposed at the joint of the inner side plates 101a, so that the sensor 1a does not impair an aesthetic appearance of the escalator 100.

### <Variation (2)>

In the first embodiment described above, the sensor 1 may be disposed on the floor portion of the entrance in addition to the balustrade 101. For example, the sensor 1 may be disposed on the landing plate 102 in addition to the place illustrated in FIG. 2.

As for the sensor 1a as illustrated in FIG. 9, the sensor 1a may be disposed on the landing plate 102 in addition to the place illustrated in FIG. 9.

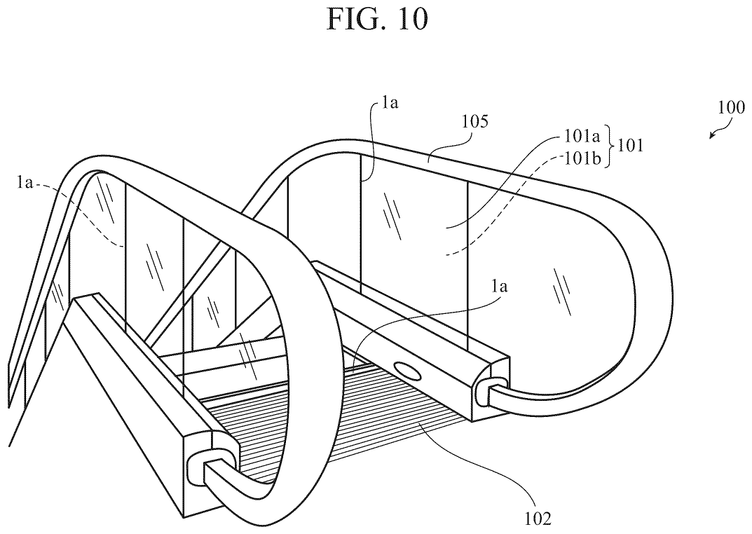

FIG. 10 is a perspective view illustrating a state of an example of the entrance of the escalator 100 in which the sensor 1a can be disposed on the landing plate 102 installed at the entrance in addition to the place illustrated in FIG. 9 in the first embodiment.

The sensor 1, 1a is disposed on the floor portion, so that the sensor 1, 1a can transmit the transmission signal to the subject from below the subject. As a result, the sensor 1, 1a can detect a detection target having a small thickness with respect to the body of the subject, in other words, having a small width in a travel direction of the subject, which might not be detected by the sensor 1, 1a disposed on the balustrade 101 that transmits the transmission signal to the subject from the side, for example.

### <Variation (3)>

In the first embodiment described above, as described with reference to FIGS. 1 and 2, one sensor 1 is disposed on each of the right and left balustrades, but this is merely an example.

A plurality of sensors 1 may be arranged on each of the right and left balustrades 101. For example, a plurality of the sensors 1 may be arranged on the surfaces of a plurality of inner side plates 101a on the balustrade 101 erected on each of both right and left sides of the step 104 in a range in which the step 104 moves.

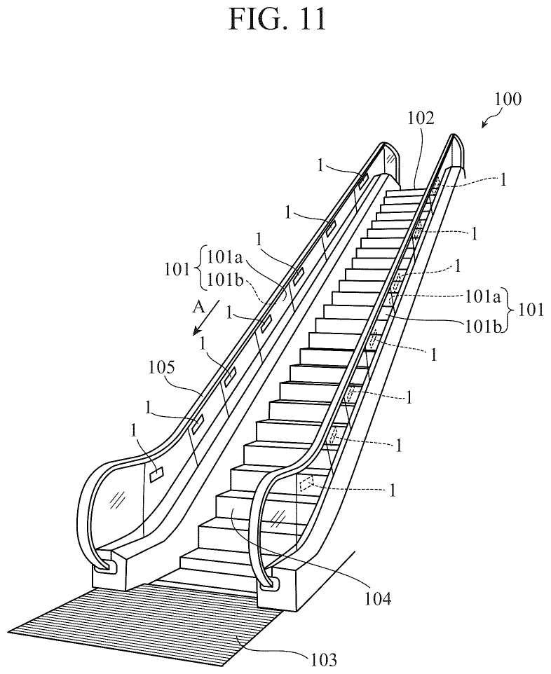

FIG. 11 is a perspective view illustrating a state of an example of the escalator 100 in which a plurality of sensors 1 is arranged on each of the right and left balustrades in the first embodiment.

In FIG. 11, the sensor 1 is disposed on the surface of each of the inner side plates 101a in the balustrade 101 erected on each of both right and left sides of the step 104 in a range in which the step 104 moves from the upper floor to the lower floor. However, this is merely an example. The sensor 1 may be disposed on the surfaces of some of the inner side plates 101a in the balustrade 101 erected on each of both right and left right sides of the step 104 in the range in which the step 104 moves from the upper floor to the lower floor, for example.

FIG. 11 illustrates a state of the escalator 100 in which a plurality of sensors 1 is arranged on each of the right and left balustrades 101, but this is merely an example, and for example, a plurality of sensors 1a as described with reference to FIG. 9 may be arranged on each of the right and left balustrades 101.

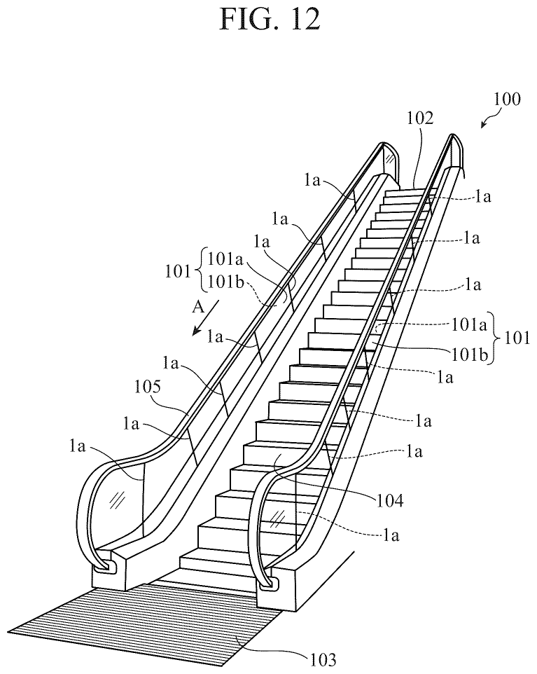

FIG. 12 is a perspective view illustrating a state of an example of the escalator 100 in which a plurality of sensors 1a is arranged on each of the right and left balustrades in the first embodiment.

A plurality of sensors 1, 1a is arranged on each of the right and left balustrades 101, so that the sensor 1, 1a can detect the detection target in a wider range, and the detection accuracy of the detection target can be improved as compared with a case where one sensor 1, 1a is disposed on each of the right and left balustrades. As a result, the detection device 2 can improve the detection accuracy of the designated target possessed by the subject.

Note that, when the detection device 2 determines whether or not the detection target detected by the sensor 1 disposed on the surface of the inner side plate 101a erected on each of both right and left sides of the step 104 in a latter half range after the step 104 starts moving within a range in which the step 104 can move is the designated target, even if the detection device 2 detects the designated target, by the time the monitoring person or the like grasps this, the subject gets off the escalator 100 to move to a place away from the escalator 100, so that the monitoring person or the like might lose sight of the subject. Therefore, the sensor 1 is preferably disposed on the surface of the inner side plate 101a erected on each of both right and left sides of the step 104 in a first half range after the step 104 starts moving within a range in which the step 104 can move.

Note that, in an example of the escalator 100 illustrated in FIGS. 11 and 12, the number of sensors 1, 1a arranged on the left balustrade and the number of sensors 1, 1a arranged on the right balustrade are the same, but this is merely an example. It is possible that the number of sensors 1, 1a arranged on the left balustrade and the number of sensors 1, 1a arranged on the right balustrade are the same or not.

In a case where a plurality of sensors 1, 1a is arranged on each of the right and left balustrades 101, the detection device 2 may display the warning image on the display device 400 depending on the position in the horizontal direction with respect to the disposing surface of the balustrade 101 in the escalator 100 on which the sensor 1, 1a is disposed.

In detail, in the detection device 2, the sensor information acquisition unit 21 sequentially acquires the sensor information from the sensor 1, 1a closer to the entrance of the escalator 100 as for a plurality of sensors 1, 1a arranged on each of the right and left balustrades 101 of the escalator 100, the determination unit 23 determines whether or not the detection target is the designated target every time the sensor information acquisition unit 21 sequentially acquires the sensor information, and the display control unit 24 causes the warning image to be displayed on the display device 400 every time the determination unit 23 determines whether or not the detection target is the designated target. That is, the display control unit 24 causes the warning image to be displayed every time the determination result is output from the determination unit 23. At that time, the display control unit 24 may cause, for example, the warning image and acquisition date and time of the sensor information on the basis of which the warning image is generated to be displayed, in other words, the sensor information for which the determination unit 23 determines the designated target, or information capable of specifying the sensor 1, 1a that acquires the sensor information, in association with the warning image.

The display control unit 24 may cause the warning images in a period set in advance to be displayed side by side in time series.

As a result, the warning image is displayed on the display device 400 together with the movement of the step 104 of the escalator 100. The detection device 2 can notify the monitoring person or the like of details of the detection of the designated target together with the movement of the step 104 of the escalator 100. For example, even in a case where the designated target that is not detected at a certain time point during the movement of the step 104 of the escalator 100 is detected at another time point, the detection device 2 can notify the monitoring person or the like of a time point at which the designated target is detected. For example, there might be a period in which it is difficult to detect the designated target due to a posture of the subject or the like. For example, in a case where the detection device 2 causes the warning image to be displayed, the monitoring person or the like can guess the posture or the like of the subject with which the designated target can be easily detected when the security check is performed by comparing the displayed warning image with the captured image.

### <Variation (4)>

In the first embodiment described above, the sensors 1 are disposed on each of the left and right inner side plates 101a in such a manner as to face each other as described with reference to FIGS. 1 and 2, but this is merely an example. For example, the left sensor and the right sensor may be disposed in such a manner that positions in the horizontal direction or the vertical direction with respect to the disposing surface of the balustrade 101 in the escalator 100 are different.

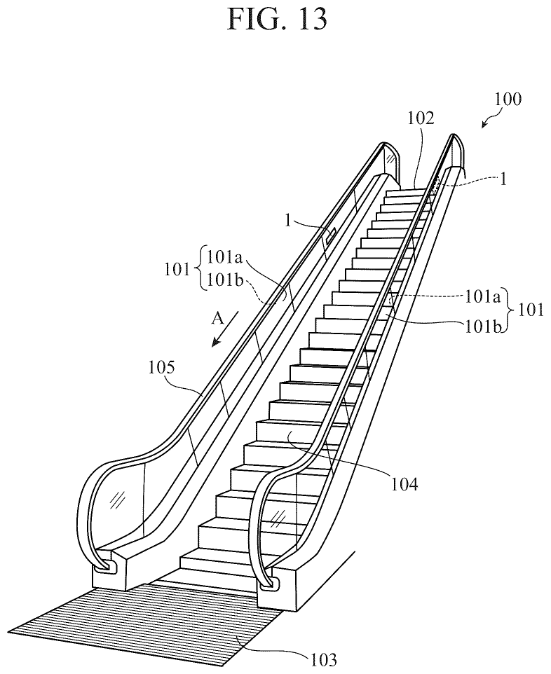

FIG. 13 is a perspective view illustrating a state of an example of the escalator 100 in which the positions in the horizontal direction and the positions in the vertical direction with respect to the disposing surface of the balustrade 101 in the escalator 100 are different between the left sensor and the right sensor in the first embodiment.

For example, the left sensor and the right sensor may be disposed in such a manner that the positions in the horizontal direction or the vertical direction with respect to the disposing surface of the balustrade 101 in the escalator 100 are different as for the sensor 1a described with reference to FIG. 9.

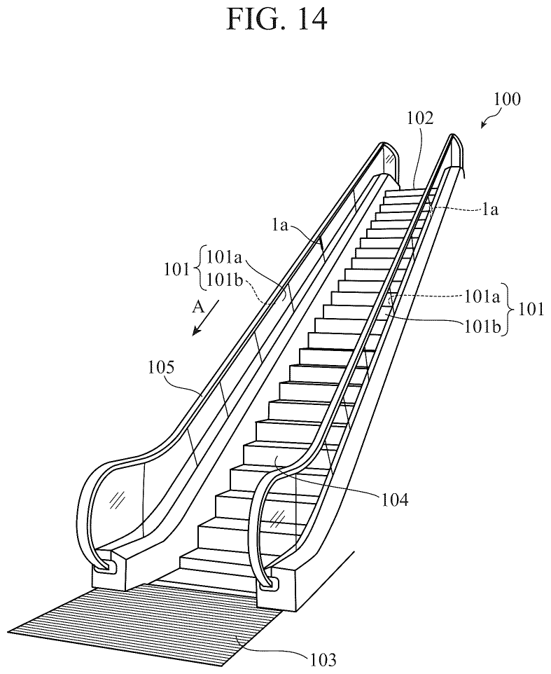

FIG. 14 is a perspective view illustrating a state of an example of the escalator 100 in which the positions in the horizontal direction and the positions in the vertical direction with respect to the disposing surface of the balustrade 101 in the escalator 100 are different between the left sensor and the right sensor as for the sensor 1a described with reference to FIG. 9 in the first embodiment. Note that, in FIG. 14, the sensor 1a is exaggerated for convenience in order to make it easy to understand that the positions in the vertical direction with respect to the disposing surface of the balustrade 101 in the escalator 100 are different.

Note that, in FIGS. 13 and 14, the left sensor and the right sensor may be disposed in such a manner that the positions in the horizontal direction or the positions in the vertical direction with respect to the disposing surface of the balustrade 101 in the escalator 100 are different, but this is merely an example. For example, between the left sensor and the right sensor, it is possible that the positions in the horizontal direction are the same and only the positions in the vertical direction are different with respect to the disposing surface of the balustrade 101 in the escalator 100, or the positions in the vertical direction are the same and only the positions in the horizontal direction are different with respect to the disposing surface of the balustrade 101 in the escalator 100.

The positions in the horizontal direction with respect to the disposing surface of the balustrade 101 in the escalator 100 are different between the left sensor and the right sensor, so that the detection range of the detection target in a front-rear direction with respect to the moving direction of the step 104 of the escalator 100 by the sensor 1, 1a in the detection system 10 is wider than that in a case where the left sensor and the right sensor are disposed in such a manner as to face each other. As a result, in the detection system 10, the detection device 2 can widen the detection range of the designated target.

The positions in the vertical direction with respect to the disposing surface of the balustrade 101 in the escalator 100 are different between the left sensor and the right sensor, so that the detection range of the detection target in the height direction by the sensor 1, 1a in the detection system 10 is wider than that in a case where the left sensor and the right sensor are disposed in such a manner as to face each other. As a result, in the detection system 10, the detection device 2 can widen the detection range of the designated target. For example, when the detection range in the height direction by the sensor 1, 1a is widened, the detection device 2 can detect that the subject possesses the designated target in the range closer to the whole body of the subject.

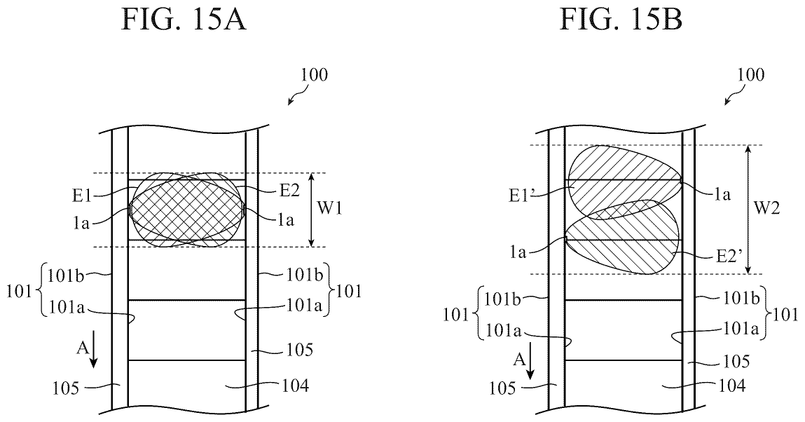

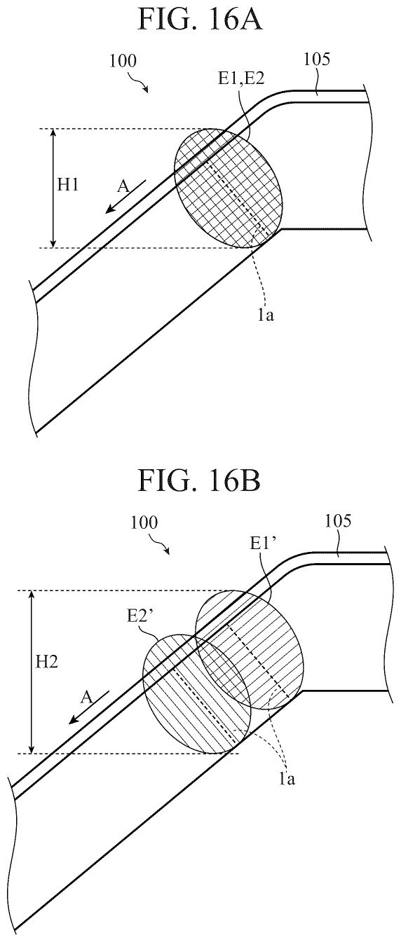

Herein, FIGS. 15A, 15B, 16A, and 16B are diagrams for describing the detection range of the left sensor and the right sensor in a case where the left sensor and the right sensor are disposed in such a manner as to face each other and a case where the left sensor and the right sensor are disposed in such a manner that the positions in the horizontal direction and the positions in the vertical direction with respect to the disposing surface of the balustrade 101 in the escalator 100 are different in the first embodiment. Note that, for convenience, the sensor illustrated in FIGS. 15A, 15B, 16A, and 16B is the sensor 1a as described with reference to FIG. 9, for example. FIGS. 15A and 15B are top views of a part of the escalator 100, and FIGS. 16A and 16B are side views of a part of the escalator 100. Note that, the step 104 is not illustrated in FIGS. 16A and 16B.

FIGS. 15A and 16A illustrate the detection range of the sensor 1a in a case where the left sensor and the right sensor are disposed in such a manner as to face each other, and FIGS. 15B and 16B illustrate the detection range of the sensor 1a in a case where the left sensor and the right sensor are disposed in such a manner that the positions in the horizontal direction with respect to the disposing surface of the balustrade 101 in the escalator 100 are different.

In FIGS. 15A, 15B, 16A, and 16B, the detection range of the left sensor is indicated by “E1” and “E1”, and the detection range of the right sensor is indicated by “E2” and “E2′”.

When the escalator 100 is seen from above, a width of the detection range of the sensor 1a in the front-rear direction with respect to the travel direction of the step 104 is larger in a case where the left sensor and the right sensor are disposed in such a manner that the positions in the horizontal direction with respect to the disposing surface of the balustrade 101 in the escalator 100 are different as compared with a case where the left sensor and the right sensor are disposed in such a manner as to face each other. For example, the width (refer to “W2” in FIG. 15B) of the detection range in the front-rear direction with respect to the travel direction of the step 104 of the sensor 1a indicated by “E1” and “E2” in FIG. 15B is larger than the width (refer to “W1” in FIG. 15A) of the detection range in the front-rear direction with respect to the travel direction of the step 104 of the sensor 1a indicated by “E1” and “E2” in FIG. 15A.

In this manner, the positions in the horizontal direction with respect to the disposing surface of the balustrade 101 in the escalator 100 are different between the left sensor and the right sensor, so that the detection range of the detection target in the front-rear direction with respect to the moving direction of the step 104 of the escalator 100 by the sensor 1, 1a in the detection system 10 is wider than that in a case where the left sensor and the right sensor are disposed in such a manner as to face each other. Herein, in a case where the passenger conveyor is the escalator 100, a difference in steps is generated in the moving direction of the step 104. Therefore, for example, in the detection system 10, even if the positions of the left sensor and the right sensor in the vertical direction with respect to the disposing surface of the balustrade 101 in the escalator 100 are the same, when the positions in the horizontal direction with respect to the disposing surface of the balustrade 101 in the escalator 100 are different, the detection device 2 can widen the detection range in the height direction of the designated target using the difference in steps.

For example, as illustrated in FIGS. 16A and 16B, when the escalator 100 is seen from the side, the width of the detection range of the sensor 1a in the height direction is larger in a case where the left sensor and the right sensor are disposed in such a manner that the positions in the horizontal direction with respect to the disposing surface of the balustrade 101 in the escalator 100 are different as compared with a case where they are disposed in such a manner as to face each other. For example, the width (refer to “H2” in FIG. 16B) of the detection range in the height direction of the sensor 1a indicated by “E1′” and “E2′” in FIG. 16B is larger than the width (refer to “H1” in FIG. 16A) of the detection range in the height direction of the sensor 1a indicated by “E1” and “E2” in FIG. 16A.

Note that, in the detection system 10, even if the positions of the left sensor and the right sensor in the horizontal direction with respect to the disposing surface of the balustrade 101 in the escalator 100 are the same, when the positions of the left sensor and the right sensor in the vertical direction with respect to the disposing surface of the balustrade 101 in the escalator 100 are different, the detection device 2 can increase the width of the detection range in the height direction of the sensor 1, 1a by using the fact that the positions of the left sensor and the right sensor in the vertical direction with respect to the disposing surface of the balustrade 101 in the escalator 100 are different.

The positions in the horizontal direction or the vertical direction with respect to the disposing surface of the balustrade 101 in the escalator 100 are different between the left sensor and the right sensor in this manner, so that the detection range by the sensor 1, 1a in the detection system 10 is wider than that in a case where the left sensor and the right sensor are disposed in such a manner as to face each other. As a result, in detection system 10, the detection device 2 can widen the detection range of the designated target. For example, when the detection range in the front-read direction by the sensor 1, 1a is widened, the detection device 2 can detect that the subject possesses the designated target in a wider range in the travel direction of the subject. For example, when the detection range in the height direction by the sensor 1, 1a is widened, the detection device 2 can detect that the subject possesses the designated target in the range closer to the whole body of the subject.

### <Variation (5)>

In the first embodiment described above, the sensor 1 may be disposed not on the surface of each of the left and right inner side plates 101a but on the surface of each of the left and right outer side plates 101b. Note that, the distance between the sensor 1 and the subject is shorter in a case where the sensor 1 is disposed on the inner side plate 101a than in a case where the sensor 1 is disposed on the outer side plate 101b. The shorter the distance from the subject is, the sensor 1 can improve the detection accuracy of the detection target. When the detection accuracy of the sensor 1 is improved, the determination accuracy of the designated target by the detection device 2 is also improved.

Note that, for example, the sensor 1a as described with reference to FIG. 9 may be disposed not on the surface of each of the left and right inner side plates 101a but on the surface of each of the left and right outer side plates 101b.

### <Variation (6)>

In the first embodiment described above, the sensor 1 may be disposed between the inner side plate 101a and the outer side plate 101b. The sensor 1 is disposed between the inner side plate 101a and the outer side plate 101b, so that this does not impair an aesthetic appearance of the escalator 100.

Note that, for example, the sensor 1a as described with reference to FIG. 9 may be disposed between the inner side plate 101a and the outer side plate 101b.

### <Variation (7)>

In the first embodiment described above, the sensor 1 can control a direction in which the transmission signal is transmitted. In detail, in the sensor 1, the signal processing unit 11 can control the direction in which the transmission unit transmits the transmission signal.

Note that, for example, the sensor 1a as described with reference to FIG. 9 can control the direction in which the transmission signal is transmitted.

For example, in the escalator 100, in a case where the left sensor and the right sensor are disposed at positions as illustrated in FIGS. 16A and 16B, the signal processing unit 11 of the right sensor may allow the transmission unit to transmit the transmission signal in a direction toward the upper floor, and the signal processing unit 11 of the left sensor may allow the transmission unit to transmit the transmission signal in a direction toward the lower floor. As a result, for example, the right sensor detects the detection target from the front of the subject, and the left sensor detects the detection target from the rear of the subject. Therefore, the detection system 10 can detect the detection target more accurately by the sensor 1a. As a result, the detection device 2 can detect the designated target possessed by the subject more accurately in the detection system 10.

As described above, in a case where the passenger conveyor is the escalator 100, a difference in steps is generated in the moving direction of the step 104. The detection system 10 can widen the detection range in the height direction by the sensor 1, 1a using the difference in steps, and can include the whole body of the subject in the detection range. For example, the detection system 10 can make the whole body of the subject the detection range of the detection target by the sensor 1, 1a by controlling the transmission direction of the transmission signal so that the sensor 1, 1a that detects the detection target from the front of the subject covers from the feet to the shoulders of the subject, and the sensor 1, 1a that detects the detection target from the rear of the subject covers from the waist to the head of the subject.

### <Variation (8)>

In the first embodiment described above, the sensor 1 and 1a is disposed on the left inner side plate and the right inner side plate, but this is merely an example.

It is possible that the sensor 1, 1a is disposed only on any one of the left inner side plate and the right inner side plate.

Note that, when the sensor 1, 1a is disposed on each of the left and right inner side plates 101a, the detection accuracy of the detection target in the detection system 10 is improved as compared with a case where the sensor 1, 1a is disposed only on any one of the left inner side plate and the right inner side plate. That is, when the sensor 1, 1a is disposed on each of the left and right inner side plates 101a, the detection accuracy of the designated target by the detection device 2 in the detection system 10 is improved as compared with a case where the sensor 1, 1a is disposed only on any one of the left inner side plate and the right inner side plate.

### <Variation (9)>

In the first embodiment described above, the detection device 2 causes the captured image and the warning image separately to be displayed on the display device 400, but this is merely an example.

For example, in the detection device 2, the display control unit 24 may causes an image in which the captured image and an image illustrating the designated target are superimposed (hereinafter, referred to as a “superimposed image”) to be displayed on the display device 400 as the warning image.

Note that, an installation position and an angle of view of the imaging device 300 are known in advance, so that the display control unit 24 can specify at which position on the captured image the detection target detected by the sensor 1, 1a is present.

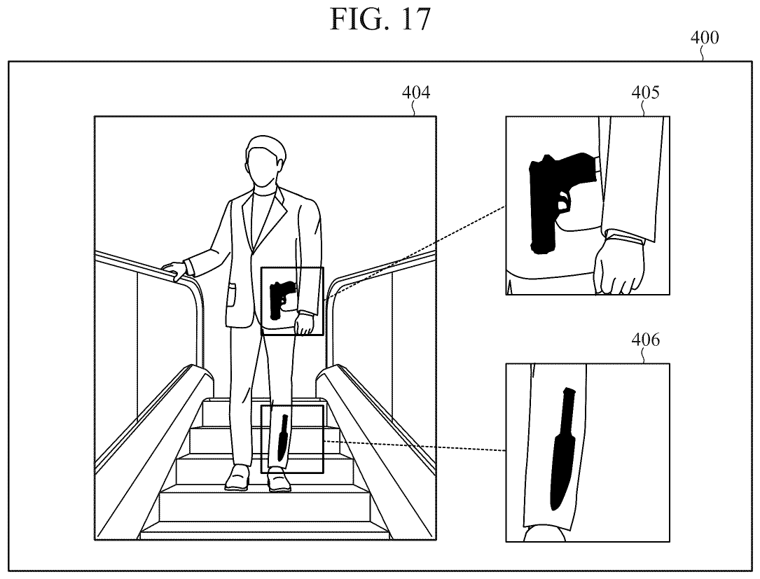

FIG. 17 is a diagram illustrating a screen example of the display device 400 in a case where the detection device 2 causes the superimposed image to be displayed on the display device 400 as the warning image in the first embodiment.

In FIG. 17, the display control unit 24 causes the superimposed image to be displayed in a fourth area (an area indicated by 404 in FIG. 17) of the display device 400.

As illustrated in FIG. 17, the display control unit 24 may display the warning image illustrating the designated target in an aspect of enlarging the designated target in the superimposed image. In FIG. 17, the display control unit 24 causes the warning image illustrating a handgun to be displayed in a fifth area (an area indicated by 405 in FIG. 17), and causes the warning image illustrating a knife to be displayed in a sixth area (an area indicated by 406 in FIG. 17).

### <Variation (10)>

In the first embodiment described above, the detection device 2 may change the designated target depending on the place where the escalator 100 in which the sensor 1 is disposed is installed.

As a specific example, for example, it is assumed that a plurality of escalators 100 is installed in a multi-story station where trains on conventional lines and the Shinkansen enter.

In this case, for example, the detection device 2 changes the designated target between a case where the escalator 100 is installed in a conventional line platform and a case where the escalator 100 is installed in a Shinkansen platform, for example. In detail, in the detection device 2, the determination unit 23 changes the designated target between a case where the escalator 100 is installed in the conventional line platform and a case where the escalator 100 is installed in the Shinkansen platform, for example.

For example, in a case where the escalator 100 is installed in the Shinkansen platform, the determination unit 23 sets a knife or a kitchen knife having a blade length set in advance as the designated target. In a case where the escalator 100 is installed in the conventional line platform, the determination unit 23 sets the knives or kitchen knives in general as the designated target regardless of the blade length.

Note that, for example, the sensor 1 stores in advance information (hereinafter referred to as “disposing place information”) capable of specifying the floor and the escalator 100 in which the sensor 1 is disposed, and outputs the disposing place information to the detection device 2 together with the sensor information. A station yard view of the station is stored in a place to which the determination unit 23 can refer. The determination unit 23 may specify an installation place of the escalator 100 on the basis of the displacement place information output from the sensor 1 and the station yard map of the station.

In another specific example, for example, a plurality of escalators 100 is assumed to be installed in a multi-story commercial facility.

In this case, for example, the detection device 2 changes the designated target depending on the floor where the escalator 100 is installed. In detail, in the detection device 2, the determination unit 23 changes the designated target depending on the floor where the escalator 100 is installed.

For example, in a case where the escalator 100 is installed in a certain floor where there is a jewelry shop, the determination unit 23 sets the number of types of metals, which are the designated targets, to be larger than that in a case where the escalator 100 is installed in a floor where there is no jewelry shop.

Note that, for example, the sensor 1 stores the disposing place information in advance, and outputs the disposing place information to the detection device 2 together with the sensor information. A floor map of a commercial facility is stored in a place to which the determination unit 23 can refer. The determination unit 23 may specify the installation place of the escalator 100 in which the sensor 1 is disposed on the basis of the disposing place information output from the sensor 1 and the floor map.

Note that, even when the sensor disposed in the escalator 100 is, for example, the sensor 1a as described with reference to FIG. 9, the detection device 2 can change the designated target depending on the place where the escalator 100 provided with the sensor 1a is installed.

### <Variation (11)>

In the first embodiment described above, the side plate is a glass panel, but this is merely an example.

For example, the side plate may be a plastic panel or a metal panel.

### <Variation (12)>

In the first embodiment described above, the side plate includes the inner side plate 101a and the outer side plate 101b, and the inner side plate 101a and the outer side plate 101b form the duplex configuration, but this is merely an example.

For example, the balustrade 101 may include a single side plate.

Note that, in the first embodiment, <Variation (1)> to <Variation (12)> described above may be applied in combination.

In the first embodiment described above, the detection device 2 is mounted on the server, but this is merely an example.

The functions of the components included in the detection device 2 may be provided in the sensor 1, 1a. For example, it is also possible that the sensor 1, 1a generates a three-dimensional radar image as the sensor information, and causes a warning image based on the generated three-dimensional radar image to be displayed on the display device 400.

In the first embodiment described above, the detection device 2 is connected to the imaging device 300, and in the detection device 2, the display control unit 24 causes the captured image captured by the imaging device 300 to be displayed on the display device 400, but this is merely an example. The display control unit 24 does not necessarily cause the captured image to be displayed on the display device 400. In a case where the display control unit 24 does not cause the captured image to be displayed on the display device 400, the detection device 2 is not necessarily connected to the imaging device 300. In a case where the display control unit 24 does not cause the captured image to be displayed on the display device 400, the processing at step ST12 can be omitted in the operation of the detection device 2 described with reference to FIG. 7.

As described above, the detection device 2 according to the first embodiment includes the sensor information acquisition unit 21 to acquire, from the sensor 1, 1a disposed on at least one of the balustrades 101 erected on both right and left sides with respect to the moving direction of the step 104 of the passenger conveyor, each of the balustrades including a plurality of side plates, the sensor to transmit the transmission signal to the space between the right and left balustrades 101 of the passenger conveyor, receive the reflection signal obtained by the transmission signal being reflected in the space, and generate the sensor information regarding the detection target on the basis of the received reflection signal, the sensor information; the determination unit 23 to determine whether or not the detection target is the designated target to be warned on the basis of the sensor information acquired by the sensor information acquisition unit 21; and the display control unit 24 to cause the warning image illustrating the designated target to be displayed on the display device 400 in a case where the determination unit 23 determines that the detection target is the designated target. Therefore, the detection device 2 can improve the detection accuracy of the designated target as compared with the conventional technology in which the designated target possessed by the subject is detected using the sensor provided on the ceiling.

In the first embodiment, the sensor 1, 1a is disposed on at least one of the balustrades 101 erected on both right and left sides with respect to the moving direction of the step 104 of the passenger conveyor, each of the balustrades including a plurality of side plates, and includes the transmission unit to transmit the transmission signal to the space between the right and left balustrades 101 of the passenger conveyor using the transmission antennas Tx1 to TxM; the reception unit to receive the reflection signal obtained by the transmission signal being reflected in the space using the reception antenna Rx1 to RxN; and the signal processing unit 11 to generate the sensor information regarding the detection target on the basis of the reflection signal acquired by the reception unit. The sensor 1, 1a is disposed on the passenger conveyor in which the criterion for installation is clearly defined, so that the sensor 1, 1a can ensure the detection accuracy of the detection target. That is, the sensor 1, 1a can accurately detect the detection target.

In the first embodiment, the detection system 10 is formed of the detection device 2 and the sensor 1, 1a as described above, so that this can improve the detection accuracy of the designated target as compared with the conventional technology in which the designated target possessed by the subject is detected using the sensor provided on the ceiling.

Note that, any component of the embodiment may be modified, or any component of the embodiment may be omitted.

### INDUSTRIAL APPLICABILITY

The detection device according to the present disclosure detects that the subject possesses the designated target by using the sensor provided on the passenger conveyor, so that this can improve the detection accuracy of the designated target as compared with the conventional technology in which the designated target possessed by the subject is detected using the sensor provided on the ceiling.

### REFERENCE SIGNS LIST

1, 1a: sensor, 11: signal processing unit, 12: transmission signal generator, 13: transmitter, 14: receiver, 15: beat signal generator, 16: A/D converter, 2: detection device, 21: sensor information acquisition unit, 22: image acquisition unit, 23: determination unit, 24: display control unit, 300: imaging device, 400: display device, 100: escalator, 101: balustrade, 101a: inner side plate, 101b: outer side plate, 102, 103: landing plate, 104: step, 105: moving handrail, 1001: processing circuit, 1002: input interface device, 1003: output interface device, 1004: processor, 1005: memory

1. A detection device comprising:
processing circuitry configured to
acquire sensor information from at least one sensor;
the at least one sensor configured to be disposed on at least one of balustrades erected on both right and left sides with respect to a moving direction of steps of at least one passenger conveyor, each of the balustrades including a plurality of side plates, the at least one sensor configured to include:
a transmitter to transmit a transmission signal to a space between the right and left balustrades of the at least one passenger conveyor using at least one transmission antenna, the at least one transmission antenna including a plurality of transmission antennas;
a receiver to receive a reflection signal obtained by the transmission signal being reflected in the space using at least one reception antenna, the at least one reception antenna including a plurality of reception antennas; and
a signal processor to generate the sensor information regarding a detection target on a basis of the received reflection signal received by the receiver, and;
a plurality of array antenna in which the plurality of transmission antennas and the plurality of reception antennas are arranged,
the transmitter transmits the transmission signal using the plurality of transmission antennas arranged linearly,
the receiver receives the reflection signal using the plurality of reception antennas linearly arranged in a same direction as a direction of the plurality of transmission antennas, and
the plurality of array antennas is linearly arranged in a height direction of a joint of the plurality of side plates on at least one of the right and left balustrades of the at least one passenger conveyor, and
determine whether or not the detection target is a designated target to be warned on a basis of the acquired sensor information; and
display a warning image indicating the designated target on a display device in a case where the processing circuitry determines that the detection target is the designated target.

2. The detection device according to claim 1, wherein
the sensor information includes information regarding a position and an azimuth of the detection target, and
the processing circuitry generates a three-dimensional radar image regarding the detection target on a basis of the sensor information, and determines whether or not the detection target is the designated target on a basis of the generated three-dimensional radar image.

3. The detection device according to claim 1,
wherein the processing circuitry is further configured to
acquire a captured image captured by an imaging device including the space, to which the sensor transmits the transmission signal, in an imaging range, and
display the warning image and the captured image having been acquired on the display device.

4. The detection device according to claim 3, wherein
the processing circuitry displays a superimposed image obtained by superimposing the captured image having been acquired and an image indicating the designated target on the display device as the warning image.

5. The detection device according to claim 1, wherein
the at least one sensor includes a plurality of sensors, and
the plurality of sensors is arranged on at least one of the right and left balustrades in a moving direction of the steps,
the processing circuitry acquires the sensor information of the plurality of sensors in a sequential order starting from the sensor close to an entrance of the at least one passenger conveyor,
the processing circuitry determines whether or not the detection target is the designated target every time the processing circuitry sequentially acquires the sensor information, and
the processing circuitry displays the warning image on the display device every time the processing circuitry determines whether or not the detection target is the designated target.

6. The detection device according to claim 1, wherein
the processing circuitry changes the designated target depending on a place where the at least one passenger conveyor provided with the sensor that outputs the sensor information is installed.

7. The detection device according to claim 6, wherein
the at least one passenger conveyor includes a plurality of passenger conveyors,
the plurality of passenger conveyors is installed at a station where local trains and express trains enter, and
the processing circuitry changes the designated target between a case where the passenger conveyor provided with the sensor that outputs the sensor information is installed in a local platform and a case where the at least one passenger conveyor provided with the sensor that outputs the sensor information is installed in an express platform.

8. The detection device according to claim 6, wherein
the at least one passenger conveyor includes a plurality of passenger conveyors,
the plurality of passenger conveyors is installed in a multi-story commercial facility, and
the processing circuitry changes the designated target depending on a floor where the at least one passenger conveyor provided with the sensor that outputs the sensor information is installed.

9. A sensor disposed on at least one of balustrades erected on both right and left sides with respect to a moving direction of steps of a passenger conveyor, each of the balustrades including a plurality of side plates, the sensor comprising:
a transmitter to transmit a transmission signal to a space between the right and left balustrades of the passenger conveyor using at least one transmission antenna, the at least one transmission antenna including a plurality of transmission antennas;
a receiver to receive a reflection signal obtained by the transmission signal being reflected in the space using at least one reception antenna, the at least one reception antenna including a plurality of reception antennas;
a signal processor to generate sensor information regarding a detection target on a basis of the reflection signal acquired by the receiver and
a plurality of array antennas in which the plurality of transmission antennas and the plurality of reception antennas, and
wherein the at least one transmitter transmits the transmission signal using the plurality of transmission antennas arranged linearly,
the at least one receiver receives the reflection signal using the plurality of reception antennas linearly arranged in a same direction as a direction of the plurality of transmission antennas, and
the plurality of array antennas is linearly arranged in a height direction of a joint of the plurality of side plates on at least one of the right and left balustrades of the passenger conveyor.

10. The sensor according to claim 9,
disposed at least one of the right and left balustrades of the passenger conveyor and a floor portion of an entrance of the passenger conveyor.

11. The sensor according to claim 9, wherein
the side plate includes an inner side plate and an outer side plate, the sensor provided between the inner side plate and the outer side plate.

12. The sensor according to claim 9, wherein
on the right and left balustrades of the passenger conveyor, a position of the sensor in a horizontal or vertical direction with respect to an installation surface of the balustrades in the passenger conveyor is different from a position of another sensor in the horizontal or vertical direction disposed on the balustrade on an opposite side.

13. The sensor according to claim 9,
disposed on one of the balustrades erected on both right and left sides of the steps in a first half range after the step starts moving within a range in which the step is movable.

14. The sensor according to claim 9, wherein
the signal processor controls a direction in which the transmitter transmits the transmission signal.

15. A detection device comprising:
processing circuitry configured to
acquire the sensor information from the sensor according to claim 9;
determine whether or not the detection target is a designated target to be warned on a basis of the acquired sensor information; and
display a warning image indicating the designated target on a display device in a case where the processing circuitry determines that the detection target is the designated target.

16. A detection system comprising:
at least one sensor configured to be disposed on at least one of balustrades erected on both right and left sides with respect to a moving direction of steps of at least one passenger conveyor, each of the balustrades including a plurality of side plates,
the at least one sensor configured to include:
a transmitter to transmit a transmission signal to a space between the right and left balustrades of the at least one passenger conveyor using at least one transmission antenna, the at least one transmission antenna including a plurality of transmission antennas;
a receiver to receive a reflection signal obtained by the transmission signal being reflected in the space using at least one reception antenna, the at least one reception antenna including a plurality of reception antennas; and
a signal processor to generate sensor information regarding a detection target on a basis of the received reflection signal received by the receiver, and
a plurality of array antenna in which the plurality of transmission antennas and the plurality of reception antennas are arranged,
the transmitter transmits the transmission signal using the plurality of transmission antennas arranged linearly,
the receiver receives the reflection signal using the plurality of reception antennas linearly arranged in a same direction as a direction of the plurality of transmission antennas, and
the plurality of array antennas is linearly arranged in a height direction of a joint of the plurality of side plates on at least one of the right and left balustrades of the at least one passenger conveyor, and
a detection device to include:
processing circuitry configured to
acquire the sensor information from the at least one sensor;
determine whether or not the detection target is a designated target to be warned on a basis of the acquired sensor information; and
display a warning image indicating the designated target on a display device in a case where the processing circuitry determines that the detection target is the designated target.

17. A detection method comprising:
acquiring sensor information from at least one sensor,
the at least one sensor configured to be disposed on at least one of balustrades erected on both right and left sides with respect to a moving direction of steps of at least one passenger conveyor, each of the balustrades including a plurality of side plates, the at least one sensor including a plurality of sensors,
the at least one sensor is further configured to include:
a transmitter to transmit a transmission signal to a space between the right and left balustrades of the at least one passenger conveyor using at least one transmission antenna, the at least one transmission antenna including a plurality of transmission antennas;
a receiver to receive a reflection signal obtained by the transmission signal being reflected in the space using at least one reception antenna, the at least one reception antenna including a plurality of reception antennas; and
a signal processor to generate the sensor information regarding a detection target on a basis of the received reflection signal received by the receiver, and
a plurality of array antenna in which the plurality of transmission antennas and the plurality of reception antennas are arranged,
the transmitter transmits the transmission signal using the plurality of transmission antennas arranged linearly,
the receiver receives the reflection signal using the plurality of reception antennas linearly arranged in a same direction as a direction of the plurality of transmission antennas, and
the plurality of array antennas is linearly arranged in a height direction of a joint of the plurality of side plates on at least one of the right and left balustrades of the at least one passenger conveyor, and
the plurality of sensors is arranged on at least one of the right and left balustrades in a moving direction of the steps,
determining whether or not the detection target is a designated target to be warned on a basis of the acquired sensor information; and
displaying a warning image indicating the designated target on a display device in a case where it is determined that the detection target is the designated target;
acquiring the sensor information of the plurality of sensors in a sequential order starting from the sensor close to an entrance of the at least one passenger conveyor;
determining whether or not the detection target is the designated target every time the sensor information is sequentially acquired; and
displaying the warning image on the display device every time it is determined whether or not the detection target is the designated target.
